(19) United States
(12) Patent Application Publication
(10) Pub. No.: US 2016/0161015 A1
(43) Pub. Date: Jun. 9, 2016

(54) APPARATUS FOR PREVENTING BREAKAGE OF VARIABLE CHARGE MOTION VALVE LINK

(71) Applicant: HYUNDAI MOTOR COMPANY, Seoul (KR)

(72) Inventor: Sung Youb PARK, Suwon-si (KR)

(21) Appl. No.: 14/733,893

(22) Filed: Jun. 8, 2015

(30) Foreign Application Priority Data
Dec. 9, 2014 (KR) 10-2014-0176010

(51) Int. Cl. F16K 31/04

(52) U.S. Cl. CPC F16K 31/047

(57) ABSTRACT

An apparatus for preventing a breakage of a variable charge motion valve link includes a first rod configured to include an insertion hole formed at one end thereof. A second rod is inserted into the first rod through the insertion hole and coupled with the first rod by a fixing pin. When an external force which is equal to or more than a threshold force value is applied to the first rod and the second rod, the second rod is separated from the first rod based on the fixing pin.

### CROSS REFERENCE TO RELATED APPLICATION

The present application claims the benefit of priority to Korean Patent Application No. 10-2014-0176010, filed Dec. 9, 2014, the entire contents of which is incorporated herein for all purposes by this reference.

### TECHNICAL FIELD

The present disclosure relates to an apparatus for preventing a breakage of a variable charge motion valve link which changes a length of a rod to prevent breakage of the variable charge motion valve link when a failure of a motor occurs.

### BACKGROUND

FIG. 1 is a diagram illustrating a variable charge motion valve apparatus according to a related art. Referring to FIG. 1, when a motor 11, which is connected to a driving shaft 13, rotates, a driving shaft valve 14 operates while the driving shaft 13 rotates by a rod 12 and a driven shaft valve 16 operates while a driven shaft 15 rotates by a valve link 17 which is present between the driving shaft 13 and the driven shaft 15.

However, when the motor 11 connected to the driving shaft fails in a state in which the driving shaft valve 14 is closed, the motor 11 is fixed when both valves 14 and 16 are closed. In this case, a strong tension stress is applied to the valve link 17 due to an excessive intake flow applied to the driven shaft 15, and thus, fatigue destruction occurs.

The valve link 17 is mounted in an intake manifold, and thus when the valve link 17 is damaged, an intake manifold assembly needs to be exchanged, and therefore maintenance costs rise.

The matters described as the related art have been provided only for assisting in the understanding for the background of the present disclosure and should not be considered as corresponding to the related art known to those skilled in the art.

### SUMMARY

An aspect of the present inventive concept provides an apparatus for preventing a breakage of a variable charge motion valve link by extending a rod when a motor fails and returning the rod to an original state when the motor is in a normal state.

According to an exemplary embodiment of the present inventive concept, an apparatus for preventing a breakage of a variable charge motion valve link includes a first rod having an insertion hole formed at one end thereof. A second rod is inserted into the first rod through the insertion hole and coupled with the first rod by a fixing pin. When an external force which is equal to or more than a threshold force value is applied to the first rod and the second rod, the second rod is separated from the first rod based on the fixing pin.

The first rod includes a first fixing hole through which the fixing pin penetrates and the second rod includes a second fixing hole through which the fixing pin penetrates to couple the first rod with the second rod.

The second rod may include a sliding hole which extends from the second fixing hole toward one end of the second rod along which the fixing pin slides when a tension stress equal to or more than a threshold stress value is applied to the second rod.

The sliding hole may have a width gradually extending from the second fixing hole toward the one end of the second rod.

The second rod may further include a buffer hole which extends from the second fixing hole toward another end of the second rod and has a gradually extending width to perform a buffer action when the fixing pin slides toward the sliding hole.

Any one of the first rod and the second rod may be connected to a motor lever and the remaining one may be connected to a variable charge motion valve lever.

The first rod and the second rod may be plastic injection molded.

After the second rod is separated from the first rod, when the motor connected to a driving shaft through the motor lever operates normally, the second rod may be inserted into the first rod by a motor driving force.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a variable charge motion valve apparatus according to the related art.

FIG. 2 is a part diagram illustrating an apparatus for preventing a breakage of a variable charge motion valve link according to an exemplary embodiment of the present inventive concept.

FIGS. 3(A) and 3(B) are assembling diagrams illustrating an operation of the apparatus for preventing a breakage of a variable charge motion valve link according to the exemplary embodiment of the present inventive concept.

### DETAILED DESCRIPTION

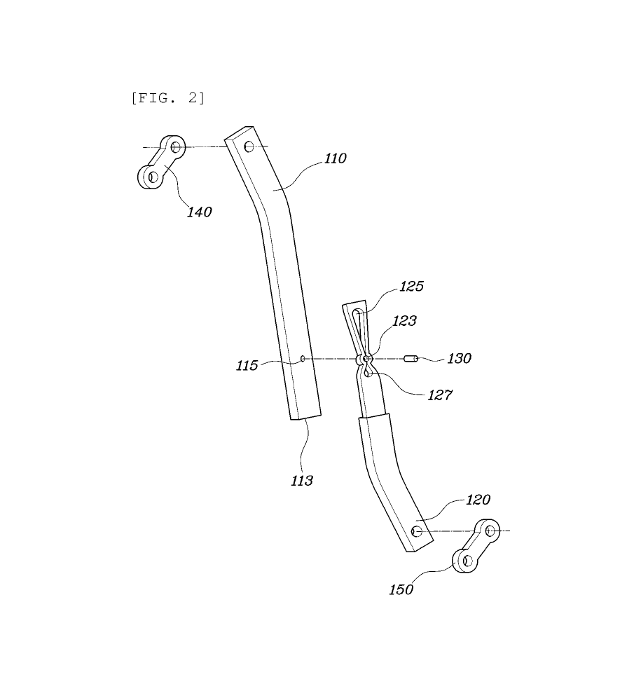

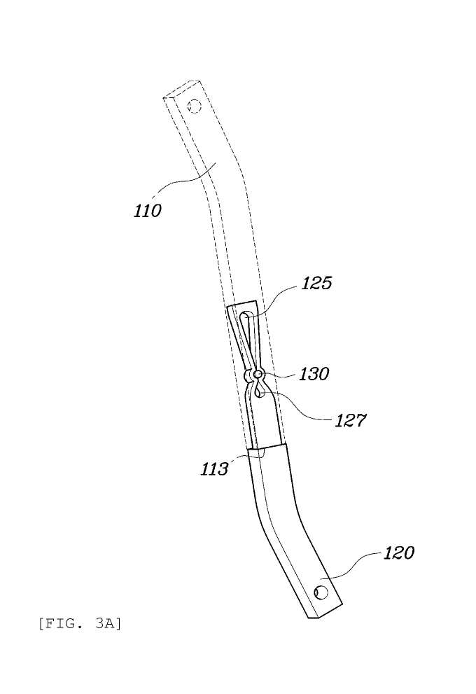

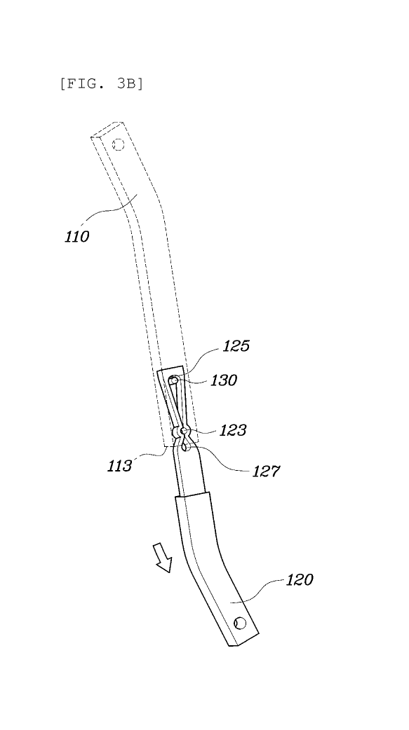

Hereinafter, an apparatus for preventing a breakage of a variable charge motion valve link according to exemplary embodiments of the present inventive concept will be described with reference to the accompanying drawings. FIG. 2 is a part diagram illustrating an apparatus for preventing a breakage of a variable charge motion valve link according to an exemplary embodiment of the present inventive concept. FIG. 3 is assembling diagram illustrating an operation of the apparatus for preventing a breakage of a variable charge motion valve link according to the exemplary embodiment of the present inventive concept.

Referring to FIGS. 2 to 3(B), the apparatus for preventing a breakage of a variable charge motion valve link includes a first rod 110 having an insertion hole 113 formed at one end thereof. A second rod 120 is inserted into the first rod 110 through the insertion hole 113 and coupled with the first rod 110 by a fixing pin 130. When an external force, which is equal to or more than a threshold value, is applied to the first rod 110 and the second rod 120, the second rod 120 is separated from the first rod 110 based on the fixing pin 130.

The first rod 110 and the second rod 120 may be plastic injection molded.

According to the exemplary embodiment of the present inventive concept, the first rod 110 and the second rod 120 are coupled with each other to connect between a motor and the variable charge motion valve. When tension or compression stress applied to the first rod 110 and the second rod 120 is equal to or more than a threshold value, as illustrated in FIG. 3(A), the second rod 120 formed to be partially inserted into the first rod 110 is partially separated from the first rod 110 to be slid downwardly as illustrated in FIG. 3(B), such that a length of the first rod 110 and the second rod 120 which are in a coupled state extends.

That is, according to the related art, when the motor connected to the driving shaft fails in a state in which a driving shaft valve of the variable charge motion valve is closed, the motor is fixed while the driving shaft valve and a driven shaft valve are closed. In this case, a strong tension stress is applied to the valve link due to an excessive intake flow applied to the driven shaft and thus fatigue destruction occurs.

However, according to the exemplary embodiment of the present inventive concept, when the motor fails, the tension stress is applied to the first rod 110 and the second rod 120 due to the intake flow which is applied to the driving shaft, such that the overall length of the first rod 110 and the second rod 120 extends to prevent the tension stress from being applied to the valve link, thereby preventing the breakage of the valve link.

In detail, the fixing pin 130 penetrates through the first fixing hole 115 which penetrates through the first rod 110 and a second fixing hole 123 which penetrates through the second rod 120 to couple the first rod 110 with the second rod 120.

In this case, the second rod 120 may include a sliding hole 125 which extends from the second fixing hole 123 to one side by a predetermined length and has the fixing pin 130 slid therealong when the tension stress which is equal to or more than the threshold value is applied to the second rod 120.

That is, when the tension stress which is equal to or more than the threshold value is applied to the first rod 110 and the second rod 120, the fixing pin 130 deviates from the second fixing hole 123 and thus enters the sliding hole 125 and slides within the sliding hole 125 depending on the tension stress. Therefore, the second rod 120 may slide, being separated from the first rod 110.

Therefore, when the motor stops and thus the tension stress is excessively applied to the first rod 110 and the second rod 120, it is possible to prevent the breakage of the valve link by extending the length of the first rod 110 and the second rod 120 which are in the coupled state.

Here, the sliding hole 125 has a width gradually extending from the second fixing hole 123 toward one side. Therefore, the fixing pin 130 may smoothly enter the sliding hole 125 and thus may perform a sliding operation.

The second rod 120 may include a buffer hole 127 which extends from the second fixing hole 123 to the other side but has a gradually extending width so as to perform a buffer action when the fixing pin 130 is separated toward the sliding hole 125. That is, when the tension stress, which is equal to or more than the threshold value, is applied to the first rod 110 and the second rod 120, the fixing pin 130 is separated from the second fixing hole 123 toward the sliding hole 125. In this case, the fixing pin 130 goes over a jaw formed in the second fixing hole 123 and thus the second rod 120 may be deformed. When the deformation is accumulated, the second rod 120 may be damaged. To prevent the deformation of the second rod 120, the buffer hole 127 which may perform the buffer action may be provided.

For example, when the fixing pin 130 enters the sliding hole 125, the width of the sliding hole 125 extends. In this case, a width of a buffer hole 127, which is provided at the opposite side, is reduced and thus the buffer hole 127 may perform the buffer action so as not to prevent the deformation of the second rod 120.

Any one of the first rod 110 or the second rod 120 is connected to a motor lever 140 and the other thereof is connected to a variable charge motion valve lever 150. That is, the first rod 110 is provided at an upper portion and the second rod 120 is provided at a lower portion, and thus, the second rod 120 may be formed to be inserted into the first rod 110 from the bottom. Alternatively, the second rod 120 is provided at the upper portion and the first rod 110 is provided at the lower portion, and thus, the second rod 120 may be inserted into the first rod 110 from the top. Therefore, the position between the first rod 110 and the second rod 120 will not be limited thereto.

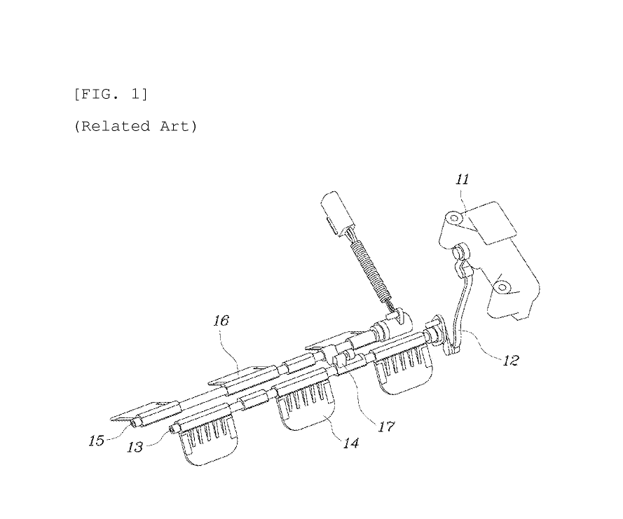

After the second rod 120 is separated from the first rod 110, when the motor connected to the driving shaft (refer to ‘13’ in the related art of FIG. 1) through the motor lever 140 is normally operated, the second rod is again inserted into the first rod 110 by a motor driving force.

That is, when the tension stress which is equal to or more than the threshold value is applied to the first rod 110 and the second rod 120 due to the failure of the motor and thus the second rod 120 slides the sliding hole 125, if the motor is recovered to the normal state, the second rod 120 again moves to the second fixing hole 123 along the sliding hole 125 by the motor driving force, such that the first rod 110 and the second rod 120 may return to the original coupled state. Therefore, a size of the second fixing hole 123 and a thickness of the sliding hole 125 are tuned by a designer depending on the tension stress which is reckoned as the threshold value and thus the separation timing of the second rod 120 may be accurately determined.

According to the apparatus for preventing a breakage of a variable charge motion valve link having the above structure, it is possible to prevent the breakage of a variable charge motion valve link by changing the length of the rod depending on the failure state of the motor.

Further, it is possible to save maintenance costs by preventing the breakage of the variable charge motion valve link which is mounted in the intake manifold to prevent the situation in which the intake manifold assembly needs to be entirely exchanged.

Although the present inventive concept has been shown and described with respect to specific exemplary embodiments, it will be obvious to those skilled in the art that the present disclosure may be variously modified and altered without departing from the spirit and scope of the present disclosure as defined by the following claims.

What is claimed is:

1. An apparatus for preventing a breakage of a variable charge motion valve link, comprising:
a first rod including an insertion hole formed at one end thereof; and
a second rod inserted into the first rod through the insertion hole and coupled with the first rod by a fixing pin,
wherein when an external force which is equal to or more than a threshold force value is applied to the first rod and the second rod, the second rod is separated from the first rod.

2. The apparatus of claim 1, wherein the first rod includes a first fixing hole through which the fixing pin penetrates and the second rod includes a second fixing hole through which the fixing pin penetrates to couple the first rod with the second rod.

3. The apparatus of claim 2, wherein the second rod includes a sliding hole which extends from the second fixing hole toward one end of the second rod along which the fixing pin slides when a tension stress equal to or more than a threshold stress value is applied to the second rod.

4. The apparatus of claim 3, wherein the sliding hole has a width gradually extending from the second fixing hole toward the one end of the second rod.

5. The apparatus of claim 3, wherein the second rod further includes a buffer hole which extends from the second fixing hole toward another end of the second rod and has a width gradually extending to perform a buffer action when the fixing pin slides toward the sliding hole.

6. The apparatus of claim 1, wherein any one of the first rod and the second rod is connected to a motor lever and the remaining one is connected to a variable charge motion valve lever.

7. The apparatus of claim 1, wherein the first rod and the second rod is plastic injection molded.

8. The apparatus of claim 6, wherein after the second rod is separated from the first rod, when the motor connected to a driving shaft through the motor lever operates normally, the second rod is inserted into the first rod by a motor driving force.
